(19) United States
(12) Patent Application Publication
(10) Pub. No.: US 2018/0157415 A1
(43) Pub. Date: Jun. 7, 2018

(54) APPARATUS AND METHOD FOR CONTROLLING MEMORY DEVICE

(71) Applicant: SK hynix Inc., Gyeonggi-do (KR)

(72) Inventors: An-Ho CHOI, Gyeonggi-do (KR); Jun-Seop CHUNG, Gyeonggi-do (KR)

(21) Appl. No.: 15/642,942

(22) Filed: Jul. 6, 2017

(30) Foreign Application Priority Data
Dec. 5, 2016 (KR) 10-2016-0164269

(51) Int. Cl. G06F 3/06; G06F 12/02

(52) U.S. Cl. CPC G06F 3/061; G06F 3/0679; G06F 2212/7205; G06F 12/0253; G06F 3/0619; G06F 3/0655

(57) ABSTRACT

A memory control apparatus may include a memory device including at least two memories respectively coupled to at least two channels, and a controller functionally coupled with the memory device. The controller may receive at least one command for performing a host task from a host, control the memory device to perform the host task with the memories based on the received command, and control the r Memory device such that, when a trigger point of a device task for a memory of the memory device is recognized, a first memory of the memory device coupled with a corresponding channel performs the device task and a second memory of the memory device coupled with the other channel process the host task.

### CROSS-REFERENCE TO RELATED APPLICATION

This application claims priority under 35 U.S.C. § 119 to Korean Patent Application No. 10-2016-0164269 filed on Dec. 5, 2016 in the Korean Intellectual Property Office, the disclosure of which is incorporated herein by reference in its entirety.

### TECHNICAL FIELD

Exemplary embodiments of the present disclosure relate to an apparatus and a method of controlling an operation of a memory device having a plurality of channels.

### DISCUSSION OF THE RELATED ART

The computer environment paradigm has shifted to ubiquitous computing systems that can be used anytime and anywhere. Due to this fact, use of portable electronic devices such as mobile phones, digital cameras, and notebook computers has rapidly increased. These portable electronic devices generally use a memory system having memory devices, that is, a data storage device. The memory system may be used as a main memory or an auxiliary memory of the portable electronic devices.

Memory systems using memory devices provide excellent stability, durability, high information access speed, and low power consumption, since they have no moving parts. Examples of memory systems having such advantages include universal serial bus (USB) memory devices, memory cards having various interfaces, and solid state drives (SSD).

A memory control apparatus may perform a host task of programming data to a memory device or reading the programmed data under control of a host. Furthermore, the memory control apparatus may control, regardless of the host, execution of a device task of controlling an operation of the memory device.

However, a memory system may not execute the host task of programming data to the memory device or reading data therefrom, when the device task is executed. For example, in a state in which the memory device performs garbage collection, the memory system may not perform an operation of programming data to the memory device or reading data therefrom under the control of the host.

### SUMMARY

Various embodiments are directed to a memory system which provides an apparatus and a method which make it possible for a memory device to perform in parallel a host task and a device task.

Various embodiments are directed to a memory system which includes memory devices coupled to a plurality of channels and provides an apparatus and a method which may control memory devices by channels in such a way that a memory device that has reached a trigger point performs a device task and a memory device coupled to another channel performs a host task.

In an embodiment, an apparatus may include: a memory device including at least two memories respectively coupled with at least two channels, and a controller functionally coupled with the memory device. The controller may receive at least one command for performing a host task from a host, control the memory device to perform the host task with the memories based on the received command, and control the memory device such that, when a trigger point of a device task for a memory of the memory device is recognized, a first memory of the memory device coupled with a corresponding channel performs the device task and a second memory of the memory device coupled with the other channel process the host task.

In an embodiment, a method of controlling a memory device including at least two memories respectively coupled with at least two channels may include: receiving at least one command for performing a host task from a host; a first control operation of transmitting the received command to the memory device coupled with the channels and controlling the memory device such that the host task is processed in parallel in the channels; and a second control operation of controlling, when a trigger point of the device task for a memory of the memory device is recognized, the memory device such that a first memory of the memory device coupled with a corresponding channel performs a device task and a second memory of the memory device coupled with the other channel process the host task.

### BRIEF DESCRIPTION OF THE DRAWINGS

FIG. 1 is a block diagram illustrating a data processing system in accordance with an embodiment of the present invention.

FIG. 2 is a diagram illustrating an example of a memory device employed in the memory system of FIG. 1.

FIG. 3 is a circuit diagram illustrating a memory block in a memory device, according to an embodiment of the present invention.

FIG. 4 is a diagram illustrating the memory blocks of the memory device of FIG. 2.

FIG. 5 is a diagram illustrating a data processing system 100 including a memory system 110 in accordance with an embodiment of the present disclosure.

FIGS. 6A and 6B are diagrams illustrating an operation of processing a command for executing a host task in a controller.

FIGS. 7A and 7B are diagrams showing examples of a channel configuration of a data processing system in accordance with various embodiments of the present disclosure.

FIG. 8 is a flowchart illustrating an operation in which a memory control apparatus controls execution of a task of a memory device in accordance with various embodiments of the present disclosure.

FIG. 9 is a flowchart illustrating an operation of executing a device task in a memory system in accordance with various embodiments of the present disclosure.

FIGS. 10 to 15 are block diagrams illustrating examples of a data processing system including a memory system according to an embodiment of the present invention.

### DETAILED DESCRIPTION

Various embodiments will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

Hereafter, various embodiments will be described in more detail with reference to the accompanying drawings.

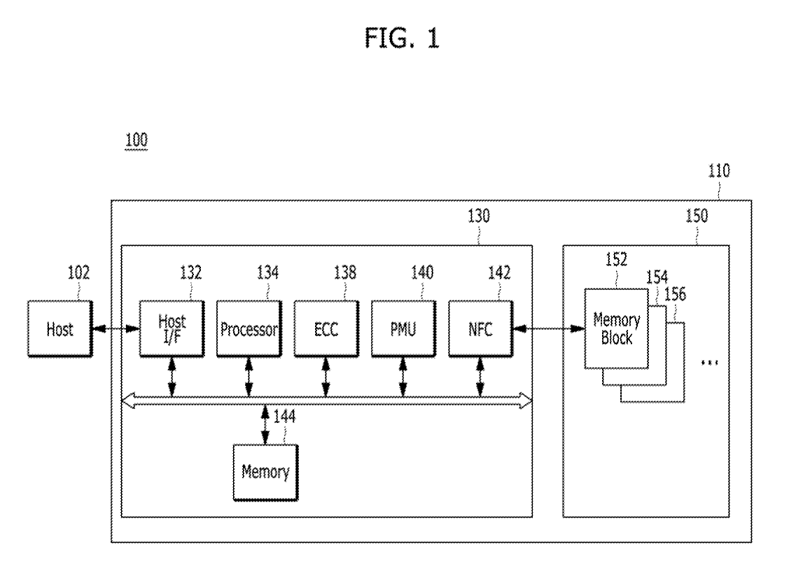

FIG. 1 illustrates a data processing system 100 including a memory system 110, according to an embodiment of the present invention.

Referring to FIG. 1, the data processing system 100 may include a host 102 and the memory system 110.

The host 102 may include, for example, a portable electronic device such as a mobile phone, an MP3 player and a laptop computer or an electronic device such as a desktop computer, a game player, a television (TV) and a projector.

The memory system 110 may operate in response to a request from the host 102. For example, the memory system 110 may store data to be accessed by the host 102. The memory system 110 may be used as a main memory or an auxiliary memory of the host 102. The memory system 110 may be implemented with any one of various storage devices, according to the protocol of a host interface to be coupled electrically with the host 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The storage devices forming the memory system 110 may be implemented with a volatile memory device, such as, a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (RRAM) and a flash memory.

The memory system 110 may include a memory device 150 and a controller 130. The memory device 150 may store data to be accessed by the host 102, and the controller 130 may control data exchange between the memory device 150 and the host 102.

The controller 130 and the memory device 150 may be integrated into one semiconductor device. For instance, the controller 130 and the memory device 150 may be integrated into one semiconductor device to form a solid state drive (SSD).

The controller 130 and the memory device 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC) an RS-MMC, a micro-MMC, a secure digital (SD) card, a mini-SD, a micro-SD, an SDHC, and a universal flash storage (UFS) device.

The memory system 110 may include the controller 130 and the memory device 150, which have a hardware structure separated from each other. In this case, the controller 130 may be a main control unit or an auxiliary control unit for an electronic device. The electronic device may be the host 102 or include some function of the host 102. For another instance, the electronic device may be an independent device physically from the host 102. The memory system 110 may configure a computer, an ultra-mobile PC (UMPC), a workstation, a net-book, a personal digital assistant (PDA), a portable computer, a web tablet, a tablet computer, a wireless phone a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage for a data center, a device capable of transmitting and receiving information under a wireless environment, one of various electronic devices for a home network, one of various electronic devices for a computer network, one of various electronic devices for a telematics network, an RFID device, or one of various component elements for a computing system.

The memory device 150 of the memory system 110 may retain stored data even when power is blocked, store the data provided from the host 102 during a write operation, and provide stored data to the host 102 during a read operation. The memory device 150 may include at least one memory block or a plurality of memory blocks, for example, 152, 154 and 155. The memory device 150 may a non-volatile memory device, for example, a flash memory.

The controller 130 of the memory system 110 may control the memory device 150 in response to a request from the host 102. The controller 130 may provide the data read from the memory device 150, to the host 102, and store the data provided from the host 102 into the memory device 150. To this end, the controller 130 may control the overall operations of the memory device 150, such as read, write program, and erase operations.

For example, the controller 130 may include a host interface (I/F) unit 132, a processor 134, an error correction code (ECC) unit 138, a power management unit (PMU) 140, a NAND flash controller (NFC) 142, and a memory 144 operatively coupled via an internal bus.

The host interface unit 132 may process commands and data provided from the host 102, and may communicate with the host 102 through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (DATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130, that is, power for the component elements included in the controller 130.

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory. In particular, when the memory device 150 is a NAND flash memory, the NFC 142 may generate control signals for the memory device 150 and process data under the control of the processor 134. When the memory device 150 is not a NAND flash memory, other well-known memory interfaces may be employed that are suitable for serving as a memory interface between the controller 130 and the memory device 150 for allowing the controller 130 to control the memory device 150 in response to a request from the host 102.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory such as a static random access memory (SRAM) or a dynamic random access memory (DRAM). As described above, the memory 144 may store data used by the host 102 and the memory device 150 for the read and write operations. For such storage of the data, the memory 144 may include a program memory, a data memory, a write buffer, a read buffer, a map buffer and so forth.

The processor 134 may control general operations of the memory system 110 including a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

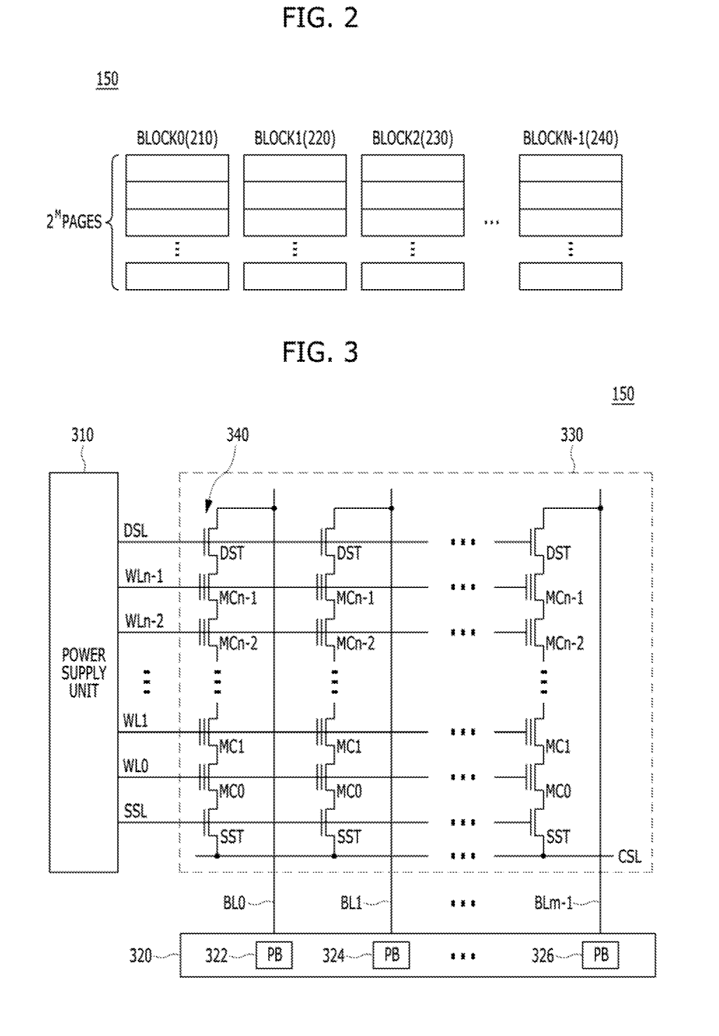

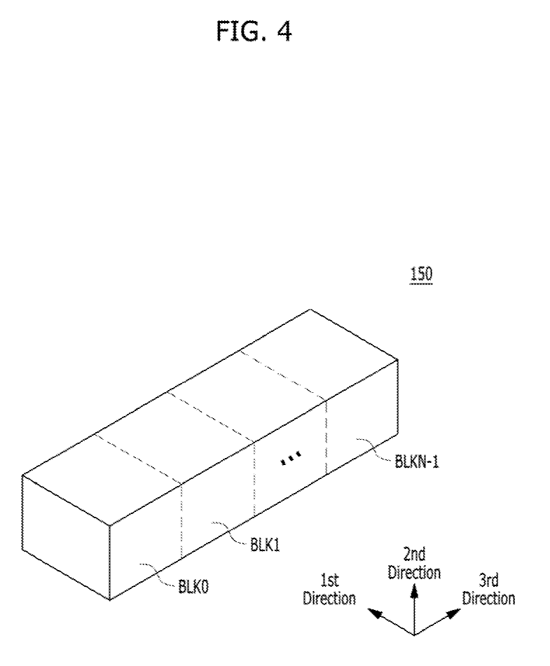

FIG. 2 is a diagram illustrating a configuration example of the memory device 150 of FIG. 1, according to an embodiment of the present invention. FIG. 3 is a circuit diagram illustrating a memory block 152 of the memory device 150 in FIG. 1. FIG. 4 is a block diagram illustrating an example of the memory device 150 of FIG. 1.

Referring to FIG. 2, the memory device 150 may include a plurality of memory blocks 210 to 240. For example, the memory device 150 may include zeroth to (N−1)^{th} memory blocks 210 to 240. Each of the plurality of memory blocks 210 to 240 may include a plurality of pages. For example, each of the plurality of memory blocks 210 to 240 may include 2^{M} number of pages (2^{M} PAGES), to which the present invention will not be limited. Each of the plurality of pages may include a plurality of memory cells electrically coupled to a word line.

Also, the memory device 150 may include a plurality of memory blocks as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data for example, two or more-bit data. The MLC memory block including a plurality of pages which are implemented with memory cells that are each capable of storing 3-bit data may be also referred to as a triple level cell (TLC) memory block.

Each of the plurality of memory blocks 210 to 240 may store the data provided from the host 102 during a write operation, and may provide stored data to the host 102 during a read operation.

Referring to FIG. 3, the memory block 152 of the memory device 150 may include a plurality of cell strings 340 which are electrically coupled to a plurality of bit lines BL0 to BLm-1, respectively. Each cell string 340 may include at least one drain select transistor DST and at least one source select transistor SST. Each cell string 340 may also include a plurality of memory cells MC0 to MCn-1 or a plurality of memory cell transistors electrically coupled in series between the at least one drain select transistor DST and the at least one source select transistor SST. Each of the memory cells MC0 to MCn-1 may be configured by a multi-level cell (MLC) which stores data information as a plurality of bits. Each of the strings 340 may be electrically coupled to a corresponding bit line among the plurality of bit lines BL0 to BLm-1. For reference, in FIG. 3, ‘DSL’ may denote a drain select line ‘SSL’ may denote a source select line, and “CSL” may denote a common source line.

While FIG. 3 illustrates, as an example, the memory block 152 of the memory device 150 which is configured by NAND flash memory cells, it is noted that the memory block 152 is not limited to NAND flash memory cells. For example, according to other embodiments, the memory block 152 may be implemented with NOR flash memory cells or hybrid flash memory cells in which at least two kinds of memory cells are combined. In an embodiment, the memory block 152 may be implemented as a one-NAND flash memory in which a controller is built in a memory chip. In an embodiment, the memory device 152 may be a flash memory device in which a charge storing layer is configured by conductive floating gates. In an embodiment, the memory device 152 may be a charge trap flash (CTF) in which a charge storing layer is configured by a dielectric layer.

A voltage supply block 310 of the memory device 150 may provide word line voltages such as a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during a program operation, and may drive the bit lines according to the received data. To this end, the read/write circuit 320 may include a plurality of page buffers 322, 324 and 326 respectively corresponding to columns or bit lines, or pairs of columns or pairs of bit lines, and a plurality of latches (not shown) may be included in each of the page buffers 322, 324 and 326.

Referring to FIG. 4, the memory device 150 may include a plurality of memory blocks BLK0 to BLKN-1, each of the memory blocks BLK0 to BLKN-1 being implemented in a three-dimensional (3D) structure also referred to as a vertical structure. Each of the memory blocks BLK0 to BLKN-1 may include structures which extend in first to third directions. The respective memory blocks BLK0 to BLKN-1 may include a plurality of cell strings for example, a plurality of NAND strings, each cell string extending in the second direction such as, in the vertical direction. The plurality of NAND strings may be spaced apart at regular intervals in the first and second directions. Each NAND string may be electrically coupled to a bit line, at least one source select line or at least one ground select line, at least one drain select line or at least one string select line a plurality of word lines, at least one dummy word line and a common source line. That is, the respective memory blocks BLK0 to BLKN-1 may be electrically coupled to a plurality of bit lines, a plurality of source select lines, a plurality of drain select lines, a plurality of word lines, a plurality of dummy word lines, and a plurality of common source lines.

Referring back to FIG. 1, the data processing system 100 according to various embodiments of the present disclosure may include the host 102, the controller 130 and the memory device 150. In the data processing system 100, a channel which couples the memory devices 150 with the controller 130 may function to transmit a command, address information and/or data from the controller 130 to the memory device 150. The controller 130 may perform one task with the memory device 150 through a single channel, and may process in parallel a plurality of tasks with the memory device 150 through a plurality of channels. In addition, with regard to a queue function, the controller 130 may receive a plurality of commands from the host 102 and reorder the commands based on a set priority or disperse the commands, thus enhancing the performance.

Hereinafter, the term “host task” refers to an operation in which the controller 130 writes data in the memory device 150 or reads written data from the memory device 150, based on a command received from the host 102. Furthermore, the term “device task” refers to a task in which the controller 130 performs a background operation of the memory device 150 in a certain state independently from the host 102. For example, the host task may be a read and/or a write operation of the memory device 150, and the device task may be a background operation for the memory device 150, such as a wearleveling operation, a garbage collection operation, a map table update operation, a rebuild operation due to a sudden power off (SPO), and a read reclaim operation.

The controller 130 may receive commands from the host 102 and store them in a queue buffer (not shown), and may control a host task such as a read or a write operation of the memory device 150 based on the commands stored in the queue buffer. The commands may include information for performing the host task. For example, when it is assumed that the maximum queue depth is sufficient for storing thirty-two commands, the controller 130 may receive and store up to 32 commands from the host 102, i.e., up to the maxim queue depth. Thereafter, when each of the buffered commands in the queue buffer of the controller 130 is processed, the controller 130 may receive a new batch of commands in response to the host 102. That is the controller 130 may receive a new batch of up to 32 commands, i.e., up to the maximum queue depth and store them in the queue buffer. Thereafter, an operation of receiving a new command at a point in time at which each of the commands stored in the queue buffer is processed may be repeatedly performed. In addition, the controller 130 may analyze the priorities of the commands that are buffered in the queue buffer, reorder the commands and execute them according to the new order of the buffered commands.

The controller 130 may set the priorities of the commands located in the queue buffer such that commands having short processing times have higher priorities than commands having long processing times. For example, the priority of a read command having a short execution time may be set higher than that of a write command having a long execution time. Furthermore, if a command of which a waiting time exceeds a preset time is present among the commands buffered in the queue buffer, the controller 130 may set the priority of the corresponding command high.

The controller 130 may distribute the reordered commands by channels to control the execution of the host task. For instance, the controller 130 may control the memory device 150 through multi-channels such that the memory device 150 of one channel executes a write command which takes a comparatively long time (having a relatively low priority), and the memory device 150 of another channel processes in parallel a read command which takes a comparatively short time (having a relatively high priority). When the controller 130 controls execution of the host tasks of the memory device 150 through the multi-channels, the controller 130 may control the execution of the host tasks such that the read and write tasks are simultaneously processed in parallel through the respective channels.

If a request for execution of a host task is made during the execution of the device task, the controller 130 may not receive a command for performing the host task from the host 102. That is, in the case where the controller 130 is coupled with the memory device 150 through a single channel, the controller 130 may not perform the host task when the memory device 150 performs the device task. To solve this, the memory device 150 according to various embodiments of the present disclosure may be coupled with the controller 130 through a plurality of channels, and the controller 130 may independently control the memory device 150 through the corresponding channels so that a host task and a device task may be performed in parallel. That is, the controller 130 in accordance with various embodiments of the present disclosure may control the memory device 150 such that the different types of operations of the memory device 150 may be performed in parallel using the multi-channel (NAND multi-channel).

The data processing system 100 in accordance with various embodiments may have a multi-channel and/or multi-way structure. For example, a solid state drive (SSD) device may have a multi-channel/multi-way structure in which a plurality of memory devices (e.g., flash memory chips) are disposed in parallel. In such structure, the controller 130 may simultaneously access a plurality flash memory chips. In accordance with various embodiment of the present disclosure, the controller 130 may control the memory device such that, if conditions of a device task are recognized, a memory device corresponding to the associated conditions performs the device task, and a memory device corresponding to other conditions performs a host task. That is, if certain conditions (e.g., conditions in which the device task should be executed) are recognized, the controller 130 may control the plurality of memory devices by channels such that the device task and the host task are processed in parallel.

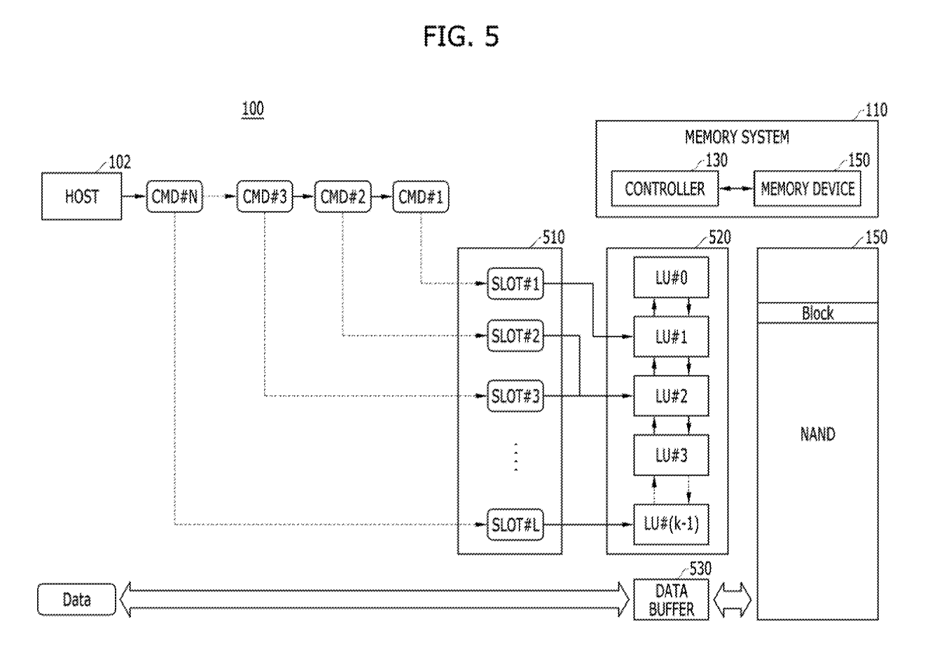

FIG. 5 is a diagram illustrating a data processing system 100 including a memory system 110 in accordance with an embodiment of the present disclosure.

Referring to FIG. 5, the data processing system 100 may include a host 102 and the memory system 110 which is a storage device functioning as a peripheral device of the host 102. The memory system 110 may include a controller 130 and a memory device 150.

First, an operation of a host task will be described. The host 102 may generate a host task including one or more commands, and transmit them to the memory system 110. For instance, the host 102 may generate a plurality of commands including an N number of commands CMD#1 to CMD#N. The memory system 110 may exchange commands and data with the host 102. A command may pertain to an operation of the memory system 110. For example, although not limited to this, the commands may include commands for search, change, read and write operations of system data on the memory system 110, and read and write operations on the memory device 150. In an embodiment, the memory device 150 may be a nonvolatile memory device such as a NAND flash memory. The memory device 150 may include a plurality of memory blocks as a data storage region.

The host 102 may communicate data with the memory system 110. The controller 130 may determine a sequence in which the controller 130 exchanges data with the host 102. For this, the controller 130 may include a data buffer 530. For example, the data buffer 530 may be embodied by a static random access memory (SRAM). In some embodiments, the data buffer 530 may be included in the memory 144 shown in FIG. 1. In another embodiment, the data buffer 530 may be provided separately from the memory 144.

During a write operation, the controller 130 may store data received from the host 102 in the data buffer 530, and thereafter may migrate the data to a certain memory block of the memory device 150 and store the data in the certain memory block. During a read operation, the controller 130 may read data stored in a certain memory block of the memory device 150 and store it in the data buffer 530, and thereafter may transmit the data stored in the data buffer 530 to the host 102. If data requested to be written/read from the host 102 has been stored in the data buffer 530, the controller 130 may not perform a write/read operation on the memory device 150.

In addition, the controller 130 of the memory system 110 may receive commands from the host 102 and determine a sequence in which the received commands are performed. For this, the controller 130 may include a receiving unit 510 and a task processing unit 520.

The receiving unit 510 may receive a plurality of commands from the host 102 through a plurality of slots. For example, the plurality of slots may include an L number of slots SLOT#1 to SLOT#L, and each command may be matched with one corresponding slot.

The task processing unit 520 may reorder commands and perform the reordered commands. For instance, the task processing unit 520 may reorder an execution sequence of the commands based on the priorities of the commands. To reorder the commands, the task processing unit 520 may include a command queue which is formed of a plurality of logical unit (LU) queues. For example, the plurality of LU queues may include a k number of LU queues LU#0 to LU#(k−1). An LU may be a unit capable of processing a command, and the LU for the memory device 150 may be determined as a unit capable of reading/writing data. For instance, in the case where the memory device 150 is a NAND flash memory, the LU may be determined as an 8, 16 or 32 KB in conjunction with a NAND structure. In the case where the memory system 110 uses an LU of 16 KB the controller 130 may perform a write operation with two 8 KB write commands as one write set. The task processing unit 520 may effectively match the slots including the respective commands received from the host 102 with the LUs which are used by the controller 130, whereby the command processing performance may be enhanced, and the command queue may be processed without missing commands or data.

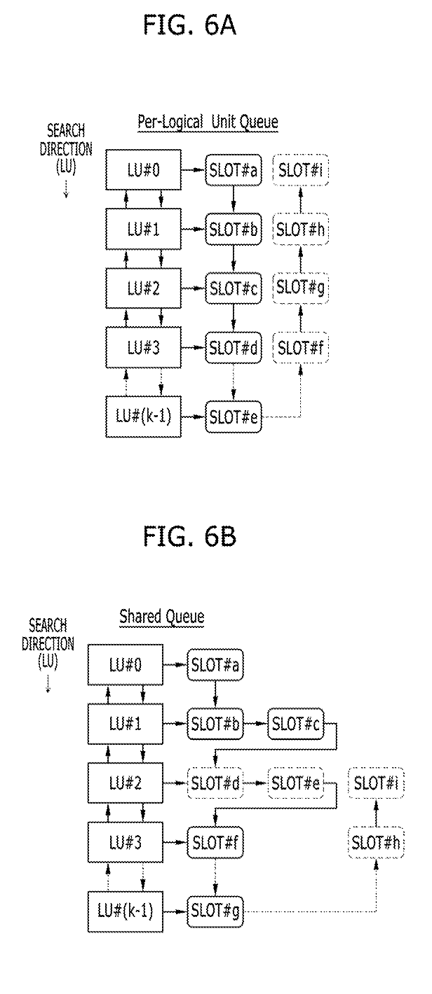

FIGS. 6A and 6B are diagrams illustrating an operation of processing commands for executing a host task in the controller. The command processing operation of FIG. 6A may be a command processing operation in accordance with a per-logical unit queue method. The command processing operation of FIG. 6B may be a command processing operation in accordance with a shared queue method.

Referring to FIG. 6A, the per-logical unit queue method may be a method in which commands (or slots) are performed in such a way that they are matched one by one with the LU s (or queues). For example, SLOT#a corresponding to LU#0 is processed, SLOT#b corresponding to LU#1 is processed, SLOT#c corresponding to LU#2 is processed, and SLOT#d corresponding to LU#3 is processed. Subsequently, SLOT#e corresponding to LU#(k−1) is processed. Thereafter, SLOT#f corresponding to LU#3 may be processed, SLOT#g corresponding to LU#2 may be processed, SLOT#h corresponding to LU#1 may be processed, and SLOT#i corresponding to LU#0 may be processed. In accordance with the per-logic unit queue method, the controller 130 may respectively match commands received from the host 102 with a plurality of LUs (or queues) for the memory device 150 and store the commands in the LUs, and may sequentially search and process the queues of the LU. This method may be advantageous in the case where the host 102 efficiently uses the LUs of the controller 130.

Referring to FIG. 6B, the shared queue method may be a method in which commands (or slots) are stored in the LUs (or queues) in a sequence in which the commands are received, and then performed. For example, SLOT#a corresponding to LU#0 is processed, SLOT#b and SLOT#c corresponding to LU#1 is processed, SLOT#d and SLOT#e corresponding to LU#2 is processed, and SLOT#f corresponding to LU#3 is processed. Subsequently, SLOT#g corresponding to LU#(k−1) is processed. Thereafter, SLOT#h corresponding to LU#3 may be processed, and SLOT#i corresponding to LU#2 may be processed. In accordance with the shared queue method, the controller 130 may store commands received from, the host 102 in the plurality of LUs (or queues) for the memory device 150 in a sequence in which the commands are received, and then may process the commands.

Second, the operation of the device task will be described, if an operation (e.g., read or write operation) pertaining to one command is completed while a host task is performed, the controller 130 may perform a test to execute a device task of the memory device 150 coupled to a corresponding channel. The device task may include at least one of wearleveling, garbage collection, and map table update. The device task may refer to a task which is executed independently from the host 102 in the memory device 150. Trigger points may be set as respective different values depending on the types of the device task. If the operation of processing the host task of the memory device 150 coupled with a corresponding channel is completed, the controller 130 may analyze conditions according to the type of each device task. When the analyzed result value satisfies conditions of a corresponding trigger point, the controller 130 may control execution of a device task of a corresponding type. The controller 130 may store trigger point values for determining whether all or some of the garbage collection, the wearleveling, the map table update, the rebuild operation due to a sudden power off (SPO), the read reclaim operation and so forth are executed.

The memory device 150 may be a fl ash memory. Each cell of the flash memory has a determined number of rewritable cycles (i.e., program/erase (P/E) Cycles), and the lifetime of the cell may be determined accordingly. In the case of the flash memory cell, it may be impossible to perform an overwrite operation. Therefore, if write tasks are focused on a certain page of the flash memory, the lifetime of the corresponding page may be reduced compared to that of other pages. In the case of an SSD, since data are dispersed and written in all pages of the memory device 150, the lifetime of the memory device 150 may be increased. That is, the controller 130 may perform a wear leveling operation in a flash translation layer (FTL), thus preventing write tasks from being focused on a certain page. In the wear leveling, a physical address coupled with a logic address may be converted or translated by correcting contents of an address translation table, and an existing page may be coupled to another logic address. The controller 130 may perform a wearleveling operation when an error bit rate exceeds a preset value in an error correction unit (not shown) or when the use time of the memory device exceeds a predetermined time. In this case, a trigger point of the wear leveling may be set based on the use time of the memory device and/or the error bit rate.

When wear leveling is performed a page that is in a written state may be marked as a garbage page (or invalid data) without erasing data from the page. As the memory device 150 is used (i.e., as a wearleveling operation is performed), garbage pages including invalid data may be gradually increased. Such garbage pages may be erased at once by performing garbage collection at an appropriate time. That is, thanks to the wearleveling, the controller 130 may make all pages be used uniformly, and it may also avoid an erase task of a block as much as possible. Since data of the garbage pages are erased at once by performing the garbage collection at an appropriate time, the number of erase tasks of the block may be reduced. Based on this, all pages of the NAND flash memory may be uniformly used. Thus, in terms of the overall SSD, there is an advantage in that the lifetime of the SSD is increased. The controller 130 may execute garbage collection of the memory device 150 corresponding to the case where the number of generated error bits exceeds a preset value in the error correction unit (not shown) or the case where the rate of data written in the memory device 150 exceeds a preset value (or the number of spare blocks of the memory is smaller than a preset value), A trigger point of the garbage collection may be set based on the number of error bits detected in the error correction unit and/or the number of spare blocks of the memory device 150.

The memory device 150 may include a plurality of memories coupled to the controller 130 through the respective channels. Each of the plurality memories may include a map table which stores address information of page storing data. When data is programmed in the memory device 150, information of map table may be changed, regarding the programmed data. Furthermore, when wearleveling or garbage collection of the memory device 150 is performed, the map table of the memory device 150 coupled with the corresponding channel may be changed. The controller 150 may update the map table of the memory device 150 coupled with each channel at a predetermined time.

In the memory device 150, when a sudden power off (SPO) is generated during a program operation, a corresponding memory block may become an open block without completing the program operation, if the open block is generated, the controller 130 may perform a rebuild operation of searching a normally programmed region (i.e., valid page data) in the open block. In this case, it may be determined whether an open block is present by the trigger point. That is, when generation of the open block is recognized, the controller 130 may stop execution of a host task of the memory device coupled with the corresponding channel and execute a device task (e.g., rebuild operation).

In the memory device 150, when read operations are repeatedly performed, an uncorrectable error correction code (UECC) may be generated in read data by changes in threshold voltages. The controller 130 may perform a read reclaim operation in a state in which a threshold voltage is changed or to be changed. The controller 130 may perform the read reclaim operation when the number of generated error bits exceeds a preset value in the error correction unit (not shown) or more, or when the number of successively generated read commands exceeds a predetermined value. In this case, the trigger point may be the number of error bits detected in the error correction unit and/or the number of successive read commands. The controller 130 may perform a wearleveling operation when the read reclaim operation is performed.

Hereinafter, a description evil I be made based on the case where the background operation of the memory device is a garbage collection, a wearleveling, or a map table update.

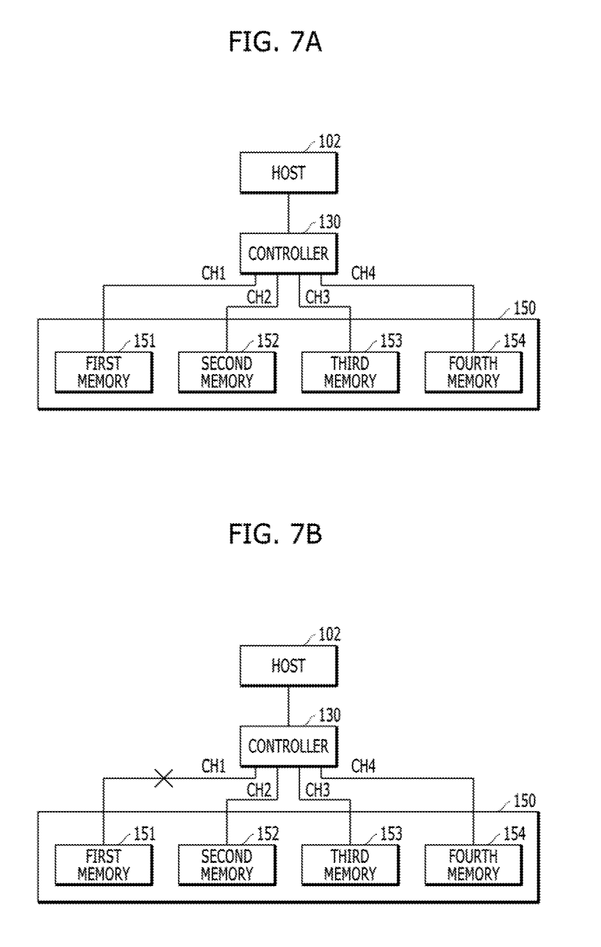

The controller 130 of the memory system in accordance with various embodiments of the present disclosure may be coupled with the memory device 150 of the memory system through a multi-channel, FIGS. 7A and 7B are diagrams showing examples of a channel configuration of a data processing system in accordance with various embodiments of the present disclosure.

Referring to FIG. 7A, the controller 130 may be coupled with the memory device 150 through a multi-channel. For instance, an eMMC as the memory system may include two channels, and an SSD as the memory system may include four to eight channels. FIG. 7A illustrates the configuration of an example of in which the memory device 150 includes first to fourth memories 151 to 154 which are coupled with the controller 130 through respective channels CH1 to CH4. The channel may include memory chips capable of sharing one input/output pin, and each of a plurality of channels (e.g. CH1 to CH4) may be coupled to at least one memory chip (e.g., at, least one of the first memory 151 to the fourth memory 154). The controller 130 may include a plurality of FTLs and control a channel range for each of the first memory 151 to the fourth memory 154 such that it is in one to one correspondence. The controller 130 may perform in parallel respective host tasks of the first memory 151 to the fourth memory 154 through the corresponding channels CH1 to CH4.

In a memory system in accordance with various embodiments of the present disclosure, when a host task is processed, the controller 130 may receive commands for performing the host task from the host 102, buffer them in a command queue, and distribute the buffered commands into the first memory 151 to the fourth memory 154. In this way, the execution of host tasks may be controlled in parallel by the controller 130. When performing a host task, the controller 130 may analyze device conditions of a corresponding memory device 150. If the corresponding memory device 150 checks conditions according to the type of a device task and recognizes that the checked conditions correspond to conditions for executing the device task (trigger point), the controller 130 may instruct the corresponding memory device 150 to execute the device task. The controller 130 may request a command for executing a host task to the host 102 if the checked conditions do not correspond to conditions for executing the device task of the corresponding memory device 150.

However, if it is recognized that the checked conditions correspond to conditions for executing the device task of the memory device 150, the controller 130 may perform the device task of the corresponding memory device 150, without transmitting response information to the host 102 (without requesting transmission of a subsequent command for performing a host task). A device task (i.e., background operation) such as garbage collection, wearleveling, or map table update may affect a host task (i.e., foreground operation) received from the host 102. When conditions of a device task are recognized, the controller 130 coupled with the memory devices 151 to 154 through the multi-channels may control the memory devices 151 to 154 such that a memory device coupled with a corresponding channel performs the device task and memory devices coupled with the other channels perform host tasks.

FIG. 7B illustrates an example in which the second memory 152 to the fourth memory 154 perform host tasks when the first memory 151 performs a device task. That is, when execution conditions of a device task of the first memory 151 are recognized, the controller 130 may control the first memory 151 such that the first memory 151 performs a corresponding device task. Simultaneously, the controller 130 may transmit commands for executing the host tasks to the second memory 152 to the fourth memory 154 through the channels CH2 to CH4 so that host tasks are performed in parallel. When it is recognized that the operation of processing the device task by the first memory 151 has been completed, the controller 130 may transmit a command to the first memory 151 through the channel CH1 again and instruct the first memory 151 to perform a host task.

In various embodiments of the present disclosure, the controller 130 may set a trigger point for determining execution of a device task. Trigger points may be set to different values depending on device tasks. The controller 130 may set a trigger point of a corresponding device task based on an error bit rate, a spare rate (i.e., the rate of an unprogrammed region) of the memory device 150, an execution time of a previous device task, the number of logs, etc. For example, when the number of error bits in a memory device of a corresponding channel exceeds a trigger point (e.g., 70 bit/1K byte), the controller 130 may instruct the memory device to execute a device task of garbage collection. For instance, when the rate of spare blocks in a memory block of a corresponding channel reaches a trigger point (e.g., 30%), the controller 130 may instruct the memory device to execute a device task of garbage collection. For example, when the use time of a memory block coupled to a corresponding channel reaches a trigger point (e.g., predetermined time), the controller 130 may instruct the memory device to execute a device task of wearleveling. When the number of map table updates of a memory block coupled to a corresponding channel exceeds a trigger point (e.g., a predetermined number of logs), the controller 130 may instruct the memory device to execute a device task of the map table update.

After a host task has been performed, the controller 130 may check conditions of a memory among the first to fourth memories 151 to 154 of a corresponding channel. If the conditions of the memory coupled with the corresponding channel meet any one condition of the above-mentioned trigger points, the controller 130 may temporarily stop a host task operation of the corresponding memory and may instruct the memory coupled with the corresponding channel to perform a device task of a corresponding type.

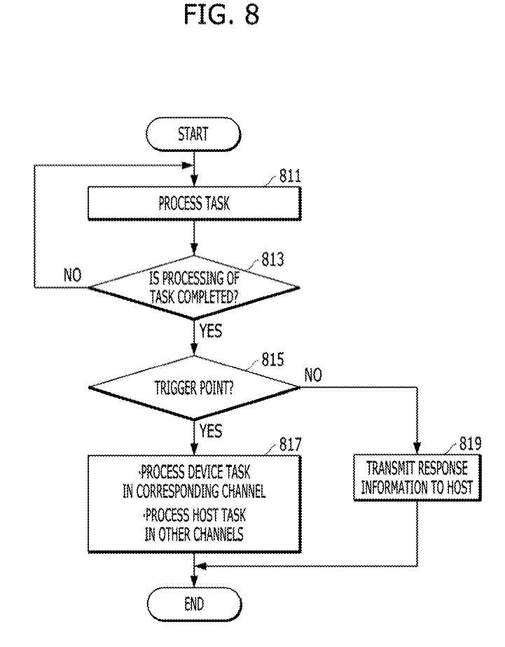

FIG. 8 is a flowchart illustrating an operation for controlling execution of a task of a memory device in a memory system in accordance with various embodiments of the present disclosure. For example, the operation of FIG. 8 may be performed by the memory system 110 including the controller 130 and the memory device 150 in FIGS. 5, 7A and 7B.

Referring to FIG. 8, the controller 130 may receive and process at least one task or command including at least one of a host task and a device task from a host 102, for the memory device 150 through a plurality of channels, at step 811. In some embodiments, the controller 130 may store the received task in the queue buffer of the controller 130, reorder and perform reordered task such that the task is distributed and provided to the various memories of the memory device 150 through the respective channels. As explained above the task may be reordered in the queue buffer based on priorities. For example, a read command may have a higher priority than a write command. In other words, the controller 130 may buffer commands in the queue buffer based on their relative priorities, and control the memory device 150 based on the priority such that high-priority command is performed. In this way, the controller 130 may control execution of the host commands of the host task. For instance, the controller 130 may control the memory device 150 such that a memory among the plurality of memories of the memory device 150 coupled with an arbitrary channel performs a read operation and a memory coupled with another channel performs a write operation. For example, at step 811, the controller 130 may control the first to fourth memories 151 to 154 coupled to the respective channels CH1 to CH4 such that the first memory 151 and the second memory 152 perform a read operation and the third memory 153 and the fourth memory 154 perform a write operation. It is assumed that a task to be processed is a host task. The host task may be an operation of writing data in a memory or reading the data written in the memory. When the operation of processing the task has been completed, at step 813, the controller 130 may recognize the completion of the host task. For example, if the operation of processing a host task in the first memory 151 coupled with the channel CH1 has been completed, the controller 130 may recognize that the operation of processing the host task in the first memory 151 has been completed, at step 813.

When the completion of the host task processing operation is recognized, the controller 130 may check whether the memory (i.e., the first memory 151) coupled with the corresponding channel satisfies conditions of executing a device task. Here, the device task may be an operation such as garbage collection, wearleveling and/or map table update. If it is determined that the corresponding first memory 151 has reached a trigger point value of a device task of a certain type, the controller 130 may instruct the first memory 151 to perform the device task of the corresponding type, at step 817. The controller 130 may then stop transmission of a command for performing a new host task to the first memory 151 which now performs the device task. The controller 130 may control the first to fourth memories 151 to 154 such that the first memory 151 performs the device task and the second memory 152 to the fourth memory 154 perform the host tasks, at step 817. However, if it is determined that the first memory 151 does not satisfy the trigger point values of device tasks of all types, at step 815, the controller 130 may recognize that the operation of processing the host task in the first memory 151 has been completed, and may transmit response information for requesting command transmission to the host 102, at step 819. In this case, the first memory 151 to the fourth memory 154 may perform the host tasks.

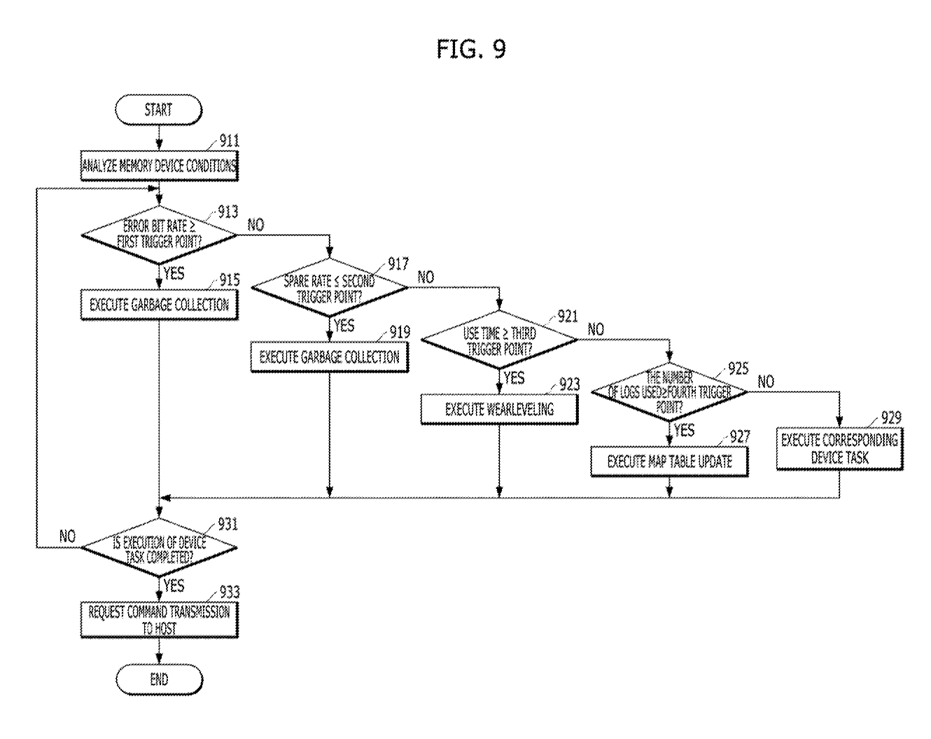

FIG. 9 is a flowchart illustrating an operation of executing a device task in a memory system in accordance with an embodiment of the present disclosure. For example, the operation of FIG. 9 may be performed by the memory system 110 including the controller 130 and the memory device 150 in FIGS. 5, 7A and 7B.

Referring to FIG. 9, when execution of a task is terminated, the controller 130 may analyze conditions for the various memories of the memory device 150 for executing a device task, at step 911. The device task may be a garbage collection, a wearleveling, a map table update, etc. A memory system in accordance with an embodiment of the present disclosure may check whether one or more device tasks among the above-described device tasks are executed whip a host task is executed. For example parameters for checking whether the device tasks are executed may include an error bit rate, a memory spare rate, a memory use time and the number of logs used. The controller 130 may include first to fourth trigger point values for determining whether the device tasks are executed based on the error bit rate, the memory spare rate, the memory use time, and the number of logs used. The controller 130 may execute in parallel the host task and the device task at the same time when the trigger point of the device task is recognized.

The controller 130 may check whether the error bit rate is greater than or equal to the first trigger point value, at step 913. If it is determined that the error bit rate is greater than or equal to the first trigger point value, the controller 130 may execute a garbage collection operation by controlling the memory among the memories of the memory device 150 which is coupled with a corresponding channel, at step 915. The controller 130 may check whether the rate (i.e., spare rate) at which data has not been programmed in a memory is less than the second trigger point value, at step 917. If it is determined that the spare rate is less than the second trigger point value, the controller 130 may execute a garbage collection operation by controlling the memory among the memories of the memory device 150 which is coupled with a corresponding channel, at step 919. The controller 130 may check whether the use time (e.g., the time for which a host task is executed) of a memory among the memories of the memory device 150 is greater than or equal to the third trigger point value, at step 921. If it is determined that the use time is greater than or equal to the third trigger point value, the controller 130 may execute a wearleveling operation by controlling the memory among the memories of the memory device 150 which is coupled with a corresponding channel, at step 923. The controller 130 may check whether the number of logs used (e.g., the number with which map table information of a memory device is changed) of a memory of the device 150 is greater than or equal to the fourth trigger point value, at step 925. If it is determined that the number of logs used is greater than or equal to the fourth trigger point value, the controller 130 may execute a map table update operation by controlling the memory of the memory device 150 coupled with a corresponding channel, at step 927.

The controller 130 may control execution of the device task by controlling the memory of the memory device 150 coupled with a certain channel, and may control execution of the host task by controlling another memory of the memory device 150 coupled with another channel. If it is determined that the execution of the device task is terminated, the controller 130 may recognize it, at step 931, and request transmission of a command for executing the host task to the host 102, at step 933. In addition, the controller 130 may control execution of the host task by transmitting a data command buffered in the queue buffer to the memory of the memory device 150 coupled with the corresponding channel.

A plurality of command queues may be set in queue depth depending on the processing performance of the controller 130. The host 102 may maintain the queue size in the maximum queue depth. If the maximum queue depth is thirty-two, the host 102 may transmit thirty-two commands to the controller 130. If transmission of a command is required by the controller 130, the host 102 may transmit a subsequent command to the controller 130 so that the commands in the controller 130 are maintained in thirty-two (i.e., maximum queue depth). The controller 130 may be coupled with the memories of the memory device 150 through the plurality of channels, and may control the execution of tasks of the memories of the memory device 150. The memories of the memory device 150 may perform a host task (i.e., foregoing or foreground operation) or a device task (i.e., background operation) under the control of the controller 130. The memory of the memory device 150 performing the device task may not execute a host task while the device task is performed, and the controller 130 may not make a request for command transmission to the host 102 during this time. The memory system in accordance with various embodiments of the present disclosure may reorder commands depending on the priorities of commands received from the multi-channel memory system, distribute the reordered commands to of the respective channels, and process in parallel a plurality of host tasks. Furthermore, when conditions of execution of a device task are satisfied while a host task is performed, the controller 130 may control the memory of the memory device 150 of the corresponding channel so that the host task and the device task are performed in parallel.

As described above, a memory control apparatus and method in accordance with various embodiments of the present disclosure may control a memory device to perform in parallel a host task of processing commands of a host and a device task of performing the memory device's own operation. A memory control apparatus and method in accordance with various embodiments of the present disclosure may set a trigger point for determining whether the device task is executed, and may separately control read and program operations of a memory device and the memory device's own operation based on the trigger point. The device task may be a background operation. The background operation may be map table update, garbage collection, wearleveling, a rebuild operation due to an SPO, a read reclaim operation, etc.

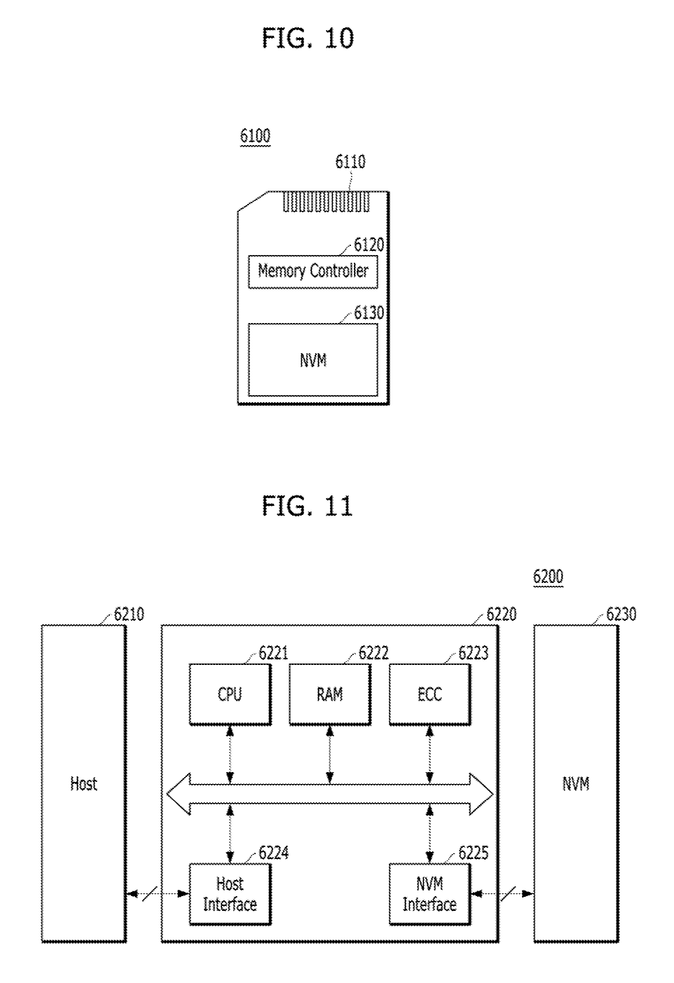

Hereinbelow, with reference to FIGS. 10 to 15, detailed descriptions will be made for electronic devices employing a memory system, according to various embodiments of the present invention.

FIG. 10 is a diagram illustrating an example of a data processing system including a memory system according to an embodiment of the present invention. For example, in FIG. 10, a memory card system 6100 employing a memory system shown, according to an embodiment of the present invention.

Referring now to FIG. 10, the memory card system 6100 is provided, according to an embodiment of the present invention.

The memory card system 6100 may include a memory controller 6120, a memory device, for example, a nonvolatile memory (NVM) 6130, and a connector 6110.

The memory controller 6120 may be operatively connected with the memory device 6130. The memory controller 6120 may access the memory device 6130 for controlling the operations of the memory device 6130. For example, the memory controller 6120 may control the read, write, erase and background operations of the memory device 6130. The memory controller 6120 is also configured to provide an interface between the memory device 6130 and a host (not shown) via the connector 6110. The memory controller 6120 may drive a firmware for controlling the memory device 6130.

The memory controller 6120 may correspond to the controller 130 in the memory system 110 described above with reference to FIG. 1, and the memory device 6130 may correspond to the memory device 150 in the memory system 110 described above with reference to FIG. 1.

Therefore, the memory controller 6120 may include components such as a random access memory (RAM), a processing unit, a host interface, a memory interface and an error correction unit.

The memory controller 6120 may communicate with an external device, for example, the host 102 described above with reference to FIG. 1, through the connector 6110. For example, as described above with reference to FIG. 1, the memory controller 6120 may be configured to communicate with the external device through at least one of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (ESDI), Integrated Drive Electronics (IDE), Firewire, universal flash storage (UFS), wireless fidelity (WI-FI) and Bluetooth. Accordingly, the memory system and the data processing system, according to an embodiment, may be applied to wired/wireless electronic appliances, and in particular, a mobile electronic appliance.

The memory device 6130 may be a nonvolatile memory (NVM). For example, the memory device 6130 may be one of various nonvolatile memory devices such as an erasable and programmable ROM (EPROM), an electrically erasable and programmable ROM (EEPROM), a NAND flash memory, a NOR flash memory, a PRAM, a resistive RAM (ReRAM), a ferroelectric RAM (FRAM) and a spin torque transfer magnetic RAM (STT-MRAM).

The memory controller 6120 and the memory device 6130 may be integrated into a single semiconductor device. For example the memory controller 6120 and the memory device 6130 may form a solid state driver (SSD) by being integrated into a single semiconductor device. Furthermore, the memory controller 6120 and the memory device 6130 may form a memory card such as a PC card (for example, Personal Computer Memory Card International Association; PCMCIA), a compact flash card (CF), a smart media card (SM and SMC), a memory stick, a multimedia card (for example, MMC, RS-MMC, MMCmicro and eMMC), an SD card (for example, SD, miniSD, microSD and SDHC) and a universal flash storage (UFS).

FIG. 11 is a diagram illustrating another example of a data processing system 6200 including a memory system according to an embodiment of the present invention.

Referring to FIG. 11, the data processing system 6200 may include a memory device 6230 which is implemented by at least one nonvolatile memory (NVM) and a memory controller 6220 which controls the memory device 6230. The data processing system 6200 shown in FIG. 11 may be a storage medium such as a memory card for example, a CF, a SD or a microSD, as described above with reference to FIG. 1. The memory device 6230 may correspond to the memory device 150 in the memory system 110 described above with reference to FIG. 1. The memory controller 6220 may correspond to the controller 130 in the memory system 110 described above with reference to FIG. 1.

The memory controller 6220 may control the operations for the memory device 6230 including read, write and erase operations in response to commands received from a host 6210. The memory controller 6220 may include at least one of a central processing unit (CPU) 6221, a buffer memory, for example, a random access memory (RAM) 6222, an error correction code (ECC) circuit 6223, a host interface 6224, and a memory interface, for example, an NVM interface 6225, all electrically coupled via an internal bus.

The CPU 6221 may control the operations for the memory device 6230 such as read, write, file system management, bad page management, and so forth. The RAM 6222 may operate according to control of the CPU 6221, and may be used as a work memory, a buffer memory, a cache memory, or the like. In the case in which the RAM 6222 is used as a work memory, data processed by the CPU 6221 is temporarily stored in the RAM 6222. In the case in which the RAM 6222 is used as a buffer memory, the RAM 6222 may be used to buffer data to be transmitted from the host 6210 to the memory device 6230 or from the memory device 6230 to the host 6210. In the case in which the RAM 6222 is used as a cache memory, the RAM 6222 may be used to enable the memory device 6230 with a low speed to operate at a high speed.

The ECC circuit 6223 may correspond to the ECC unit 138 of the controller 130 described above with reference to FIG. 1. As described above with reference to FIG. 1, the ECC circuit 6223 may generate an error correction code (ECC) for correcting a fail bit or an error bit in the data received from the memory device 6230. Also the ECC circuit 6223 may perform error correction encoding for data to be provided to the memory device 6230, and generate data added with parity bits. The parity bits may be stored in the memory device 6230. The ECC circuit 6223 may perform error correction decoding for data outputted from the memory device 6230. At this time, the ECC circuit 6223 may correct errors by using the parity bits. For example, as described above with reference to FIG. 1C, the ECC circuit 6223 may correct errors by using one of various coded modulations such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM) and a Block coded modulation (BCM).

The memory controller 6220 may transmit and receive data to and from the host 6210 through the host interface 6224, and transmit and receive data to and from the memory device 6230 through the NVM interface 6225. The host interface 6224 may be connected with the host 6210 through at least one of various interface protocols such as a parallel advanced technology attachment (PATA) bus, a serial advanced technology attachment (SATA) bus, a small computer system interface (SCSI), a universal serial bus (USB), a peripheral component interconnection express (PCIe) or a NAND interface. Further, as a wireless communication function or a mobile communication protocol such as wireless fidelity (WI-FI) or long term evolution (LTE) is implemented, the memory controller 6220 may transmit and receive data by being connected with an external device such as the host 6210 or another external device other than the host 6210. Specifically, as the memory controller 6220 is configured to communicate with an external device through at least one among various communication protocols, the memory system and the data processing system according to the embodiment may be applied to wired/wireless electronic appliances, and in particular, a mobile electronic appliance.

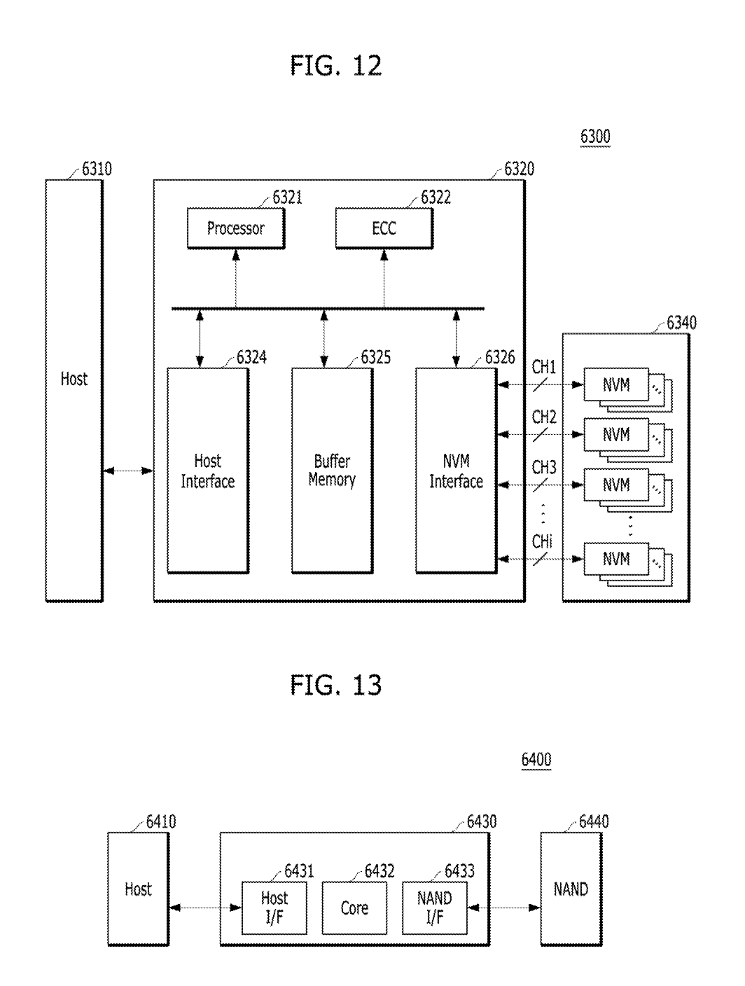

FIG. 12 is a diagram illustrating another example of a data processing system including a memory system according to an embodiment of the present invention. For example, in FIG. 12, a solid state drive (SSD) 6300 employing a memory system is shown, according to an embodiment of the present invention.

Referring to FIG. 12, the SSD 6300 may include a memory device 6340 which may include a plurality of nonvolatile memories (NVM), and a controller 6320. The controller 6320 may correspond to the controller 130 in the memory system 110 described above with reference to FIG. 1. The memory device 6340 may correspond to the memory device 150 in the memory system 110 described above with reference to FIG. 1.

The controller 6320 may be connected with the memory device 6340 through a plurality of channels CH1, CH2, CH3, . . . , CHi. The controller 6320 may include at least one of a processor 6321, a buffer memory 6325, an error correction code (ECC) circuit 6322, a host interface 6324, and a memory interface such as a nonvolatile memory (NVM) interface 6326.

The buffer memory 6325 may temporarily store data received from a host 6310 or data received from a plurality of nonvolatile memories NVM included in the memory device 6340, or temporarily store metadata of the plurality of nonvolatile memories NVM. For example, the metadata includes map data including mapping tables. The buffer memory 6325 may be implemented by a volatile memory such as, but not limited to, a dynamic random access memory (DRAM), a synchronous dynamic random access memory (SDRAM), a double data rate (DDR) SDRAM, a low power double data rate (LPDDR) SDRAM and a graphic random access memory (GRAM) or a nonvolatile memory such as, but not limited to, a ferroelectric random access memory (FRAM), a resistive random access memory (ReRAM), a spin-transfer torque magnetic random access memory (STT-MRAM) and a phase change random access memory (PRAM). Although it is illustrated in FIG. 12, as an example, that the buffer memory 6325 is disposed inside the controller 6320, it is noted that the buffer memory 6325 may be disposed outside the controller 6320.

The ECC circuit 6322 may calculate error correction code values of data to be programmed in the memory device 6340 in a program operation, perform an error correction operation for data read from the memory device 6340 based on the error correction code values in a read operation, and perform an error correction operation for data recovered from the memory device 6340 in a recovery operation for failed data.

The host interface 6324 may provide an interface function with respect to an external device such as the host 6310. The nonvolatile memory interface 6326 may provide an interface function with respect to the memory device 6340 which is connected through the plurality of channels CH1, CH2, CH3, . . . CHi.

In an embodiment, a redundant array of independent disks (RAID) system is provided, the system including a plurality of SSDs 6300. Each SSD 6300 may employ the memory system 110 described above with reference to FIG. 1. In a RAID system, the plurality of SSDs 6300 and a RAID controller for controlling the plurality of SSDs 6300 may be included. In the case of performing a program operation by receiving a write command from the host 6310, the RAID controller may select at least one memory system, that is, at least one SSD 6300, corresponding to the RAID level information of the write command received from the host 6310 among a plurality of RAID levels, that is, the plurality of SSDs 6300, and may output data corresponding to the write command, to the selected SSD 6300. Also, in the case of performing a read operation by receiving a read command from the host 6310, the RAID controller may select at least one memory system, that is, at least one SSD 6300, corresponding to the RAID level information of the write command received from the host 6310, among the plurality of RAID levels, that is, the plurality of SSDs 6300, and may provide data outputted from the selected SSD 6300, to the host 6310.

FIG. 13 is a diagram illustrating another example of a data processing system including a memory system, according to an embodiment of the present invention. For example, in FIG. 13, an embedded multimedia card (eMMC) 6400 employing a memory system is shown, according to an embodiment of the present invention.

Referring to FIG. 13, the eMMC 6400 may include a memory device 6440 which is implemented by at least one NAND flash memory, and a controller 6430. The controller 6430 may correspond to the controller 130 in the memory system 110 described above with reference to FIG. 1. The memory device 6440 may correspond to the memory device 150 in the memory system 110 described above with reference to FIG. 1.

The controller 6430 may be connected with the memory device 6440 through a plurality of channels indicated by the two headed arrow. The controller 6430 may include a host interface 6431, at least one core 6432, and a memory interface, for example, a NAND interface 6433.

The core 6432 may control the operations of the eMMC 6400, the host interface 6431 may provide an interface function between the controller 6430 and a host 6410, and the NAND interface 6433 may provide an interface function between the memory device 6440 and the controller 6430. For example, the host interface 6431 may be a parallel interface such as an MMC interface, as described above with reference to FIG. 1, or may be a serial interface such as an ultra-high speed (UHS)-I/UHS-II and a universal flash storage (UFS) interface.

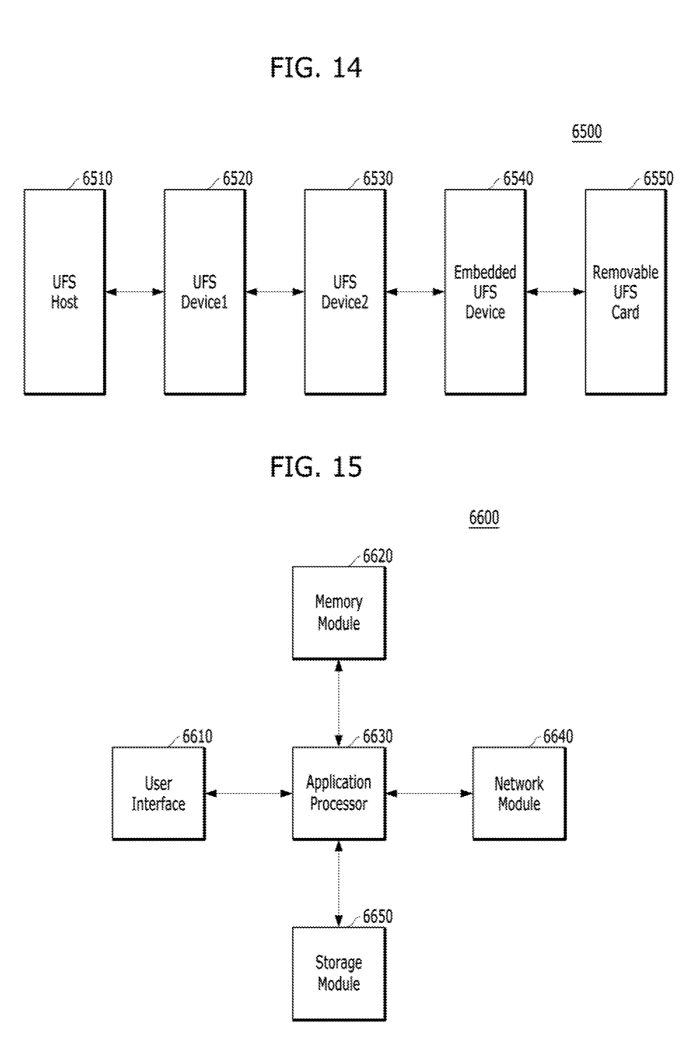

FIG. 14 is a diagram illustrating another example of a data processing system including a memory system, according to an embodiment of the present invention. For example, in FIG. 14, a universal flash storage (UFS) system 6500 employing a memory system is shown, according to an embodiment of the invention.

Referring to FIG. 14, the UFS system 6500 may include a UFS host 6510, a plurality of UFS devices 6520 and 6530, an embedded UFS device 6540, and a removable UFS card 6550. The UFS host 6510 may be an application processor of wired/wireless electronic appliances, and in particular, a mobile electronic appliance.

The UFS host 6510, the UFS devices 6520 and 6530, the embedded UFS device 6540 and the removable UFS card 6550 may respectively communicate with external devices, that is, wired/wireless electronic appliances, and in particular, a mobile electronic appliance, through a UFS protocol. The UFS devices 6520 and 6530, the embedded UFS device 6540 and the removable UFS card 6550 may be implemented as the memory system 110 described above with reference to FIG. 1 and in particular, as the memory card system 6100 described above with reference to FIG. 10. The embedded UFS device 6540 and the removable UFS card 6550 may communicate through another protocol other than the UFS protocol. For example, the embedded UFS device 6540 and the removable UFS card 6550 may communicate through various card protocols such as, but not limited to, USB flash drives (UFDs), a multimedia card (MMC), secure digital (SD), mini SD and Micro SD.

FIG. 15 is a diagram illustrating another example of a data processing system including a memory system according to an embodiment of the present invention. For example, in FIG. 15, a user system 6600 employing a memory system is shown, according to an embodiment of the present invention.

Referring to FIG. 15, the user system 6600 may include a user interface 6610, a memory module 6620, an application processor 6630, a network module 6640 and a storage module 6650.

The application processor 6630 may drive components included in the user system 6600 and an operating system (OS). For example, the application processor 6630 may include controllers for controlling the components included in the user system 6600, interfaces, graphics engines, and so on. The application processor 6630 may be provided as a system-on-chip (SoC).

The memory module 6620 may operate as a main memory, a working memory, a buffer memory or a cache memory of the user system 6600. The memory module 6620 may include a volatile random access memory such as a dynamic random access memory (DRAM), a synchronous dynamic random access memory (SDRAM), a double data rate (DDR) SDRAM, a DDR2 SDRAM, a DDR3 SDRAM an low power double data rate (LPDDR) SDRAM, an LPDDR2 SDRAM and an LPDDR3 SDRAM or a nonvolatile random access memory such as a phase change random access memory (PRAM), a ReRAM, a magnetic random access memory (MRAM) and a ferroelectric random access memory (FRAM). For example, the application processor 6630 and the memory module 6620 may be mounted as a package-on-package (POP).

The network module 6640 may communicate with external devices. For example, the network module 6640 may support not only wired communications but also various wireless communications such as code division multiple access (CDMA) global system for mobile communication (GSM) wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), and so on, and may thereby communicate with wired/wireless electronic appliances, and in particular, a mobile electronic appliance. Accordingly, the memory system and the data processing system may be applied to wired/wireless electronic appliances. The network module 6640 may be included in the application processor 6630.

The storage module 6650 may store data such as data received from the application processor 6630, and transmit data stored therein, to the application processor 6630. The storage module 6650 may be implemented by a nonvolatile semiconductor memory device such as a phase-change RAM (PRAM), a magnetic RAM (MRAM), a resistive RAM (ReRAM), a NAND flash memory, a NOR flash memory and a 3-dimensional NAND flash memory. The storage module 6650 may also be provided as a removable storage medium such as a memory card of the user system 6600 and an external drive. That is, the storage module 6650 may correspond to the memory system 110 described above with reference to FIG. 1, and may be implemented as the SSD, eMMC and UFS described above with reference to FIGS. 12 to 14.

The user interface 6610 may include interfaces for inputting data or commands to the application processor 6630 or for outputting data to an external device. For example, the user interface 6610 may include user input interfaces such as a keyboard, a keypad, a button, a touch panel, a touch screen, a touch pad, a touch ball, a camera a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

In the case in which the memory system 110 described above with reference to FIG. 1 is applied to the mobile electronic appliance of the user system 6600 according to an embodiment, the application processor 6630 may control the operations of the mobile electronic appliance, and the network module 6640 as a communication module controls wired/wireless communication with an external device, as described above. The user interface 6610 as the display/touch module of the mobile electronic appliance displays data processed by the application processor 6630 or supports input of data from a touch panel.

Although various embodiments have been described for illustrative purposes, it will be apparent to those skilled in the art that various changes and modifications may be made without departing from the spirit and scope of the disclosure as defined in the following claims.

What is claimed is:

1. An apparatus comprising:
a memory device including at least two memories respectively coupled to at least two channels; and
a controller functionally coupled with the memory device,
wherein the controller receives at least one command for performing a host task from a host,
wherein the controller controls the memory device to perform the host task with the memories based on the received command, and
wherein when a trigger point of a device task for a memory of the memory device is recognized, the controller controls the memory device such that a first memory of the memory device coupled with a corresponding channel performs the device task, and a second memory of the memory device coupled with the other channel process the host task.

2. The apparatus of claim 1, wherein
the host task comprises a read and/or write task, and
the device task comprises at least one of garbage collection, wearleveling, and map table update tasks.

3. The apparatus of claim 2,
wherein when the processing of the host task is completed, the controller analyzes a condition of the memory device coupled with each corresponding channel, and
wherein when the condition of the memory device corresponds to the trigger point of the device task, the controller interrupts the performing of the host task and performs the device task.

4. The apparatus of claim 3,
wherein when the trigger point of the memory device is not recognized, the controller makes a request for transmission of a command for performing the host task to the host, and
wherein the controller transmits a subsequent host task from a queue buffer to the memory device coupled with the corresponding channel.

5. The apparatus of claim 3,
wherein the device task is the garbage collection, and
wherein when the number of error bits in data read from the memory device coupled with the corresponding channel is greater than or equal to the trigger point, the controller controls execution of the garbage collection of the memory device.

6. The apparatus of claim 3,
wherein the device task is the garbage collection, and
wherein when a spare rate of the memory device coupled with the corresponding channel is less than the trigger point or, the controller controls execution of the garbage collection of the memory device.

7. The apparatus of claim 3,
wherein the device task is the wearleveling, and
wherein when use time of the memory device coupled with the corresponding channel is greater than or equal to the trigger point, the controller controls execution of the wearleveling of the memory device.

8. The apparatus of claim 3,
wherein the device task is the map table update, and
wherein when the map table update of the memory device coupled with the corresponding channel is greater than or equal to the trigger point, the controller controls execution of the map table update of the memory device.

9. The apparatus of claim 4,
wherein when the execution of the device task of the memory device is completed, the controller makes a request for transmission of a command for executing the host task to the host, and
wherein the controller transmits a command stored in the queue buffer to the memory device that has processed the device task.

10. The apparatus of claim 9, wherein the controller divides the received command into a read command and a write command and distributes the read command and the write command to the channels.

11. A method of controlling a memory device including at least two memories respectively coupled with at least two channels, comprising:
receiving at least one command for performing a host task from a host;
a first control operation of transmitting the received command to the memory device coupled with the channels and controlling the memory device such that the host task is processed in parallel in the channels; and
a second control operation of controlling, when a trigger point of the device task for a memory of the memory device is recognized, the memory device such that a first, memory of the memory device coupled with a corresponding channel performs a device task and a second memory of the memory device coupled with the other channel process the host task.

12. The method of claim 11,
wherein the host task comprises a read and/or write task, and
wherein the device task comprises at least one of garbage collection, wearleveling, and map table update tasks.

13. The method of claim 12, further comprising:
analyzing a condition of the memory device coupled with the corresponding channel when the processing of the host task is completed, and
wherein the second control operation comprises interrupting the performing of the host task and performing the device task, when the condition of the memory device corresponds to the trigger point of the device task.

14. The method of claim 13, further comprising:
making a request for transmission of a command for performing the host task to the host, when the trigger point of the memory device is not recognized; and
transmitting a subsequent host task from a queue buffer to the memory device coupled with the corresponding channel.

15. The method of claim 13,
wherein the device task is the garbage collection, and
wherein the second control operation comprises controlling execution of the garbage collection of the memory device when the number of error bits in data read from the memory device coupled with the corresponding channel is greater than or equal to the trigger point.

16. The method of claim 13,
wherein the device task is the garbage collection, and
wherein the second control operation comprises controlling execution of the garbage collection of the memory device when a spare rate of the memory device coupled with the corresponding channel is less than the trigger point.

17. The method of claim 13,
wherein the device task is the wearleveling, and
wherein the second control operation comprises controlling execution of the wearleveling of the memory device when use time of the memory device coupled with the corresponding channel is greater than or equal to the trigger point.

18. The method of claim 13,
wherein the device task is the map table update, and
wherein the second control operation comprises controlling execution of the map table update of the memory device when the map table update of the memory device coupled with the corresponding channel is greater than or equal to the trigger point.

19. The method of claim 14, further comprising:
making a request for transmission of a command for executing the host task to the host, when the execution of the device task of the memory device is completed; and
transmitting a command stored in the queue buffer to the memory device that has processed the task.

20. The method of claim 19, wherein the transmitting of the command to the memory device comprises distributing a read command and a write command to the memory devices coupled with the channels.
